(19) United States
(12) Patent Application Publication
(10) Pub. No.: US 2008/0313888 A1
(43) Pub. Date: Dec. 25, 2008

(54) Tool for bearings

(76) Inventor: Michael Mueller, Bad Staffelsdein (DE)

Correspondence Address: ROSENBERG, KLEIN & LEE, 3458 ELLICOTT CENTER DRIVE-SUITE 101, ELLICOTT CITY, MD, 21043, US

(21) Appl. No.: 11/819,008

(22) Filed: Jun. 25, 2007

(51) Int. Cl. B23P 19/04

(52) U.S. Cl. 29/724

(57) ABSTRACT

A bearing tool includes a first ring, whose inner diameter is larger than the outer diameter of the inner ring of the bearing and whose outer diameter is larger than the inner diameter of the outer ring of the bearing; a second ring, which is coaxial with the first ring, has an outer diameter smaller than the inner diameter of the first ring and the inner diameter of the outer ring of the bearing, and has an inner diameter smaller than the outer diameter of the inner ring of the bearing; and a force-exerting part, which provides an action force to change the axial relative position between the coaxial first and second rings. The bearing is coaxially held between the first and second rings, so that one end in the axis of the first ring urges against the opposite surface of the outer ring of the bearing and one end in the axis of the second ring urges against the opposite surface of the inner ring of the bearing. The action of the force-exerting part is mediated by the first and second rings to change the axial relative position between the inner and outer rings of the bearing.

### BACKGROUND OF THE INVENTION

1. Field of Invention

The invention relates to a tool and, in particular, to a bearing tool that changes the axial relative position between the inner and outer rings of the bearing.

2. Related Art

Up to date, there is no appropriate tool for changing the axial relative position between the inner and outer rings of a bearing. Therefore, to take out the inner ring in the prior art, one has to use a knocking tool that destroy the bearing. Also, there is no appropriate tool for replace the rollers in the bearing. In view of the foregoing, it is an objective of the invention to provide a tool for changing the axial relative position between the inner and outer rings of a bearing.

### SUMMARY OF THE INVENTION

This specification provides a bearing tool for changing the axial relative position between the inner and outer rings of a bearing. According to the objective, the disclosed bearing tool includes a first ring, a second ring, and a force-exerting part.

The first ring has an inner diameter larger than the outer diameter of the inner ring of a bearing and an outer diameter larger than the inner diameter of the outer ring of the bearing. The second ring is coaxial with the first ring. Its outer diameter is smaller than the inner diameter of the first ring and the inner diameter of the outer ring of the bearing. Its inner diameter is smaller than the outer diameter of the inner ring of the bearing. The force exerting part allows the user to exert a force on the first and second rings, changing the axial relative position thereof.

Using the tool, the bearing is held coaxially between the first and second rings. One end in the axis of the first ring touches against the opposite surface of the outer ring of the bearing. One end in the axis of the second ring touches against the opposite surface of the inner ring of the bearing. The action of the force exerting part is mediated by the first and second rings to change the axial relative position between the inner and outer rings.

### BRIEF DESCRIPTION OF THE DRAWINGS

The invention will become more fully understood from the detailed description given herein below illustration only, and thus is not limitative of the present invention, and wherein:

FIG. 1 is a three-dimensional exploded view of the preferred embodiment of the invention;

FIG. 2 is a three-dimensional assembled view of the preferred embodiment;

FIG. 3 is a cross-sectional view of FIG. 2 along the 3-3 direction;

FIG. 4 is a schematic view of using the preferred embodiment to change the axial relative position between the inner and outer rings of the bearing; and

FIG. 5 is a schematic view showing the result after using the preferred embodiment.

### DETAILED DESCRIPTION OF THE INVENTION

The present invention will be apparent from the following detailed description, which proceeds with reference to the accompanying drawings, wherein the same references relate to the same elements.

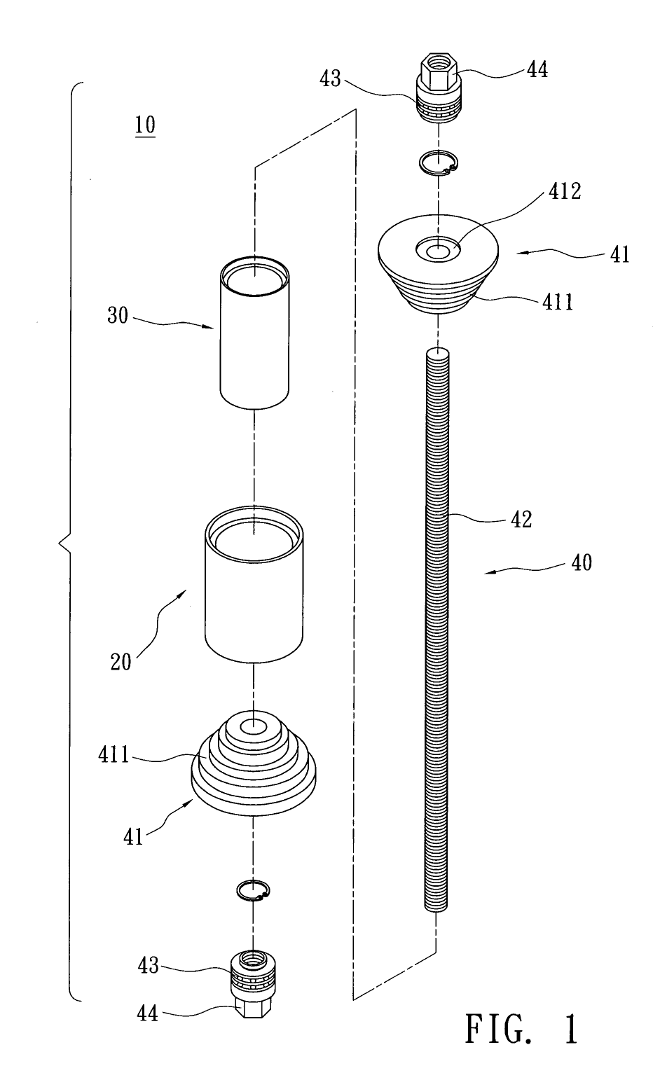

FIG. 1 shows a preferred embodiment of the invention. However, it should not be construed to restrict the scope of the invention.

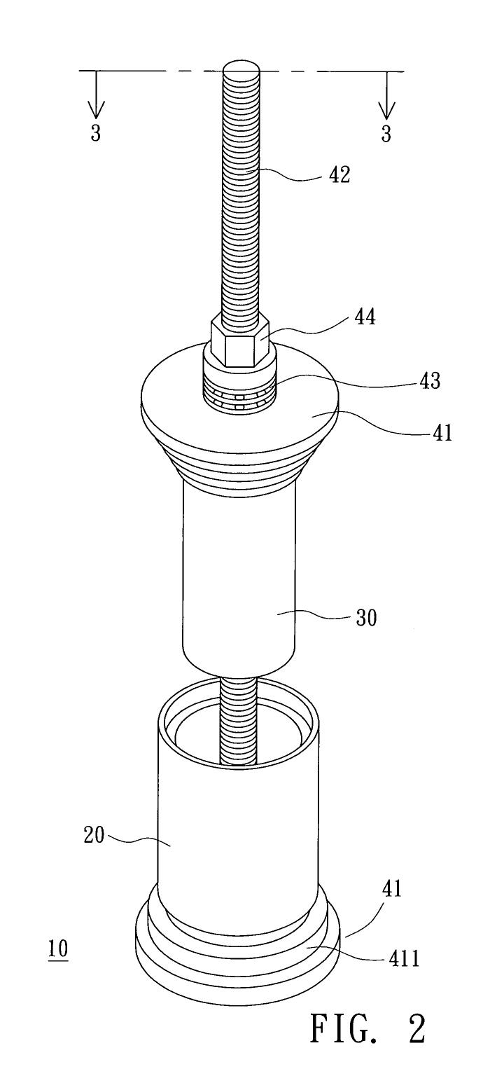

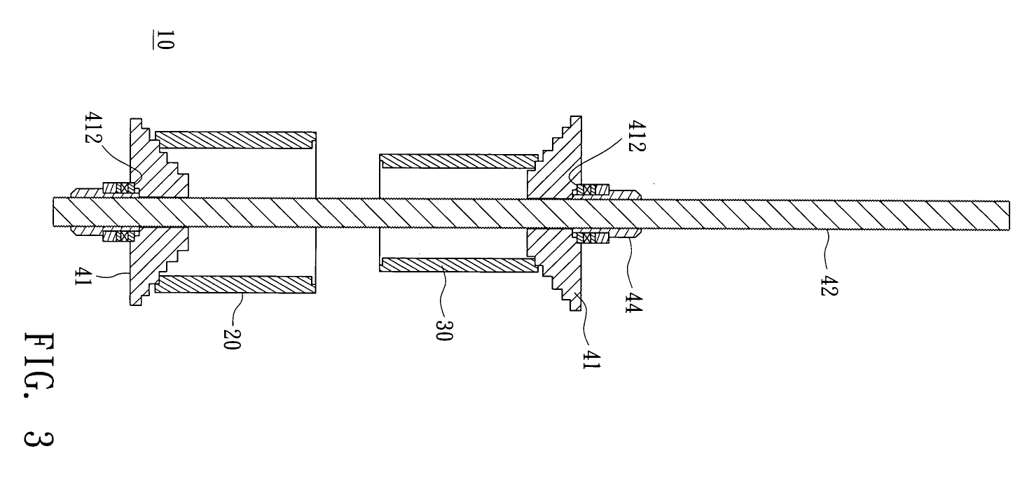

As shown in FIGS. 1 to 3, the mounting tool 10 for changing the axial relative position between the inner and outer rings of a bearing according to the preferred embodiment has a first ring 20, a second ring 30, and a force-exerting part 40.

The first ring 20 is a circular tube of appropriate length, inner ring, and outer ring, so that its one end urges against the end surface of the outer ring of the bearing. More explicitly, its inner diameter has to be greater than the outer diameter of the inner ring of the bearing, avoiding direct contact between the end surface of the outer ring and the first ring 20. Its outer diameter has to be greater than the inner diameter of the outer ring of the bearing, forming direct contact between the first ring and the end surface of the outer ring of the bearing.

The second ring 30 is also a circular tube of appropriate length, inner diameter, and outer diameter, and is coaxial with the first ring 20. It urges against the end surface of the inner ring of the bearing. More explicitly, its outer diameter has to be smaller than the inner diameter of the first ring 20 and the inner diameter of the outer ring of the bearing simultaneously, thereby allowing the second ring 30 to go through the interior of the first ring 20 and avoiding direct contact with the outer ring of the bearing. Its inner diameter is smaller than the outer diameter of the inner ring of the bearing, forming direct contact between the second ring 30 and the inner ring of the bearing.

The force-exerting part has two disk ends 41, using a ladder-like end surface 411 to urge against opposite tubes of the first and second rings 20, 30. A screw rod 42 goes through the first and second rings 20, 30 coaxially, with both ends extending out from the two disk ends 41. Two thrust bearings 43 are mounted on the two ends of the screw rod 42 and embedded in the grooves 412 on the corresponding ends 41. Two nuts 44 are provided on the two ends of the screw rod 42. Each of the thrust bearings 43 pushes against the corresponding end 41.

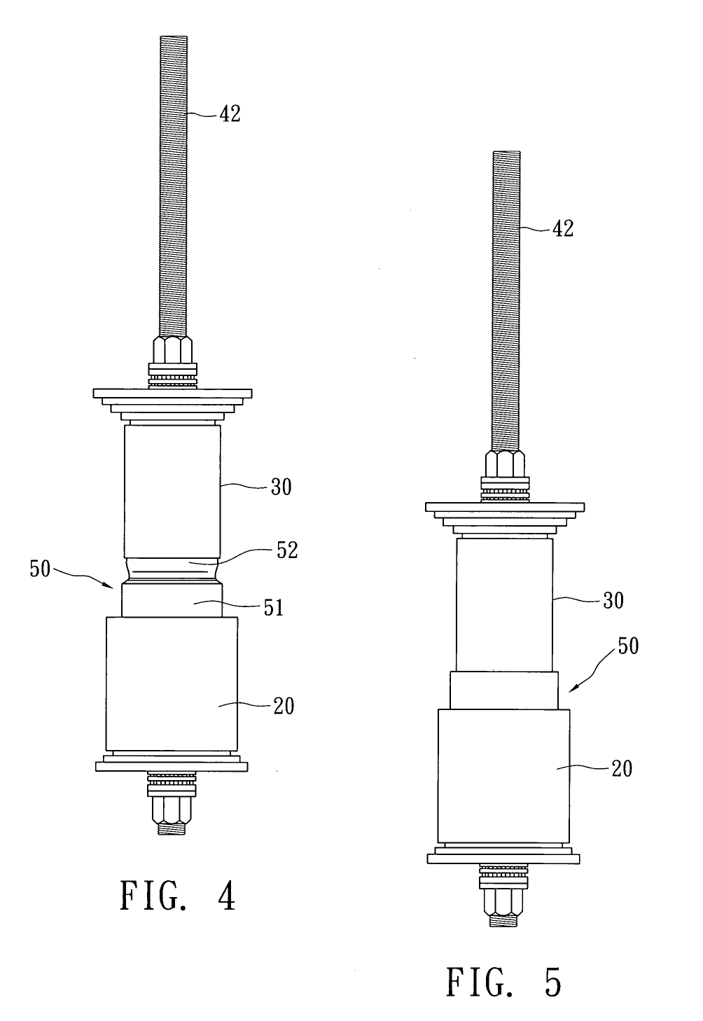

With reference to FIGS. 4 and 5, the mounting tool 10 for changing the axial relative position of the inner and outer rings holds the bearing 50 coaxially between opposite surfaces of the first and second rings 20, 30. The first ring 20 urges against one end of the outer ring 51 of the bearing, so that the second ring 30 urges against one end of the inner ring 52 of the bearing. Therefore, when an external force is imposed to rotate the nut 44, the relative position between the first and second rings 20, 30 is changed so that the axial relative position between the inner and outer rings 51, 52 is changed as well. This achieves the goal of installing or uninstalling the inner ring.

It should be emphasized that the above-mentioned embodiment serves as only one example of the invention. The force-exerting part 40 can be replaced by manual knocking or a hydraulic power tool, instead of the above-mentioned screw rod.

Moreover, the sizes of the first and second rings 20, 30 in the embodiment can be modified according to different bearings. Such differences should be included as simple variations of the invention. The ends 41 with a ladder-like end surface are designed to fit different sizes of the first and second rings 20, 30, so that the invention can be used for different sizes of first and second rings.

Besides, the number of rings can be increased according to needs. Different rings are connected in series. Such variations are also included as part of the invention.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A bearing tool, comprising:
a first ring, whose inner diameter is larger than the outer diameter of the inner ring of a bearing and whose outer diameter is larger than the inner diameter of the outer ring of the bearing;
a second ring, which is coaxial with the first ring and whose outer diameter is smaller than the inner diameters of the first ring of the outer ring of the bearing and whose inner diameter is smaller than the outer diameter of the inner ring of the bearing;
a force-exerting part, which provides an action force to change the axial relative position between the coaxial first and second rings;
wherein the bearing is coaxially held between the first and second rings so that one end in the axis of the first ring urges against the opposite surface of the outer ring of the bearing, one end in the axis of the second ring urges against the opposite surface of the inner ring of the bearing, the action of the force-exerting part is mediated by the first and second rings to change the axial relative position between the inner and outer rings of the bearing.

2. The bearing tool of claim 1, wherein the force-exerting part has two ends embedded respectively in opposite sides of the first and second rings, a screw rod coaxially penetrates through the first and second rings with its two ends going through the two ends, and two nuts are provided on the two ends of the screw rod.

3. The bearing tool of claim 2, wherein the force-exerting part includes two thrust bearings mounted on the two ends of the screw rod and between the nuts and the end surfaces.

4. The bearing tool of claim 3, wherein each of the ends is formed with a groove for accommodating the corresponding thrust bearing.

5. The bearing tool of claim 2, wherein each of the ends has a ladder-like surface on the end that urges against the corresponding ring.
